(19) United States
(12) Patent Application Publication
(10) Pub. No.: US 2026/0249547 A1
(43) Pub. Date: Aug. 27, 2026

(54) SYSTEMS AND METHODS FOR DUAL-WAVELENGTHS, TWO-PHOTON PRINTING TO CREATE HIGH-RESOLUTION, MULTI-MATERIAL 3D STRUCTURES

(71) Applicant: Lawrence Livermore National Security. LLC, Livermore, CA (US)

(72) Inventors: Magi Mettry YASSA, Antioch, CA (US); James Spencer OAKDALE, Castro Valley, CA (US); Yoonsoo RHO, Pleasanton, CA (US); Xiaoxing XIA, Pleasanton, CA (US)

(21) Appl. No.: 19/065,702

(22) Filed: Feb. 27, 2025

(51) Int. Cl. B29C 64/135; B29C 64/273; B29C 64/393; B33Y 10/00; B33Y 30/00; B33Y 50/02

(52) U.S. Cl. CPC B29C 64/135; B29C 64/273; B29C 64/393; B33Y 10/00; B33Y 30/00; B33Y 50/02

(57) ABSTRACT

The present disclosure relates to a method for two photon printing using a quantity of photo-polymerizable material having a first material photo-polymerizable via an optical signal at a first wavelength, and a second material photo-polymerizable via an optical signal at a second wavelength. The method involves generating a first optical beam at a first wavelength and a second optical beam at a second wavelength different from the first wavelength, and then coaxially aligning the beams. The beams are then directed into an objective lens which focuses the beams to an image plane on or within the polymerizable material. The coaxially aligned beams are steered within the image plane and selectively photo-polymerize at least one of the first or second materials.

### FEDERALLY SPONSORED RESEARCH OR DEVELOPMENT

This invention was made with Government support under Contract No. DE-AC52-07NA27344 awarded by the United States Department of Energy. The Government has certain rights in the invention.

### FIELD

The present disclosure relates to 2PP 3D printing systems and methods, and more particularly to new systems and methods which make use of dual wavelengths for 2PP printing to create high-resolution 3D parts using two resin formulations.

### BACKGROUND

The statements in this section merely provide background information related to the present disclosure and may not constitute prior art.

Two photon polymerization (2PP): 2PP is a direct laser writing 3D printing method capable of printing submicron features with unprecedented accuracy. It uses a high numerical aperture objective to focus femtosecond laser (typically, ~800 nm) pulses into a diffraction-limited spot, where two-photon polymerization is activated inside a spatially confined voxel. High resolution 3D printing is achieved by scanning this voxel in space. Typically, 2PP relies on free radical polymerization triggered by photoinitiation. However, it is believed that nothing in prior known work involving 2PP has contributed to any multi wavelength control that can achieve orthogonal multi material chemistry and enhance resolution via advanced beam shaping.

### SUMMARY

This section provides a general summary of the disclosure, and is not a comprehensive disclosure of its full scope or all of its features.

In one aspect the present disclosure relates to a method for two photon printing using a quantity of photo-polymerizable material having a first material photo-polymerizable via an optical signal at a first wavelength, and a second material photo-polymerizable via an optical signal at a second wavelength. In some embodiments, the first material may be photo-polymerizable at a first wavelength, and the second material may be photo-polymerizable at a second wavelength different than the first wavelength. The method may comprise generating a first optical beam at a first wavelength, and generating a second optical beam at a second wavelength different from the first wavelength. The method may further comprise coaxially aligning the first and second optical beams and directing the coaxially aligned first and second optical beams into an objective lens disposed elevationally apart, along a Z-axis, from the quantity of photo-polymerizable material containing the first and second materials. The objective lens focuses the coaxially aligned optical beams to an image plane on or within the quantity of polymerizable material. The method further comprises steering the coaxially aligned optical beams within the image plane and using the first and second optical beams to selectively photo-polymerize: the first material using the first wavelength, or both the first material and the second material simultaneously using the second wavelength.

In another aspect the present disclosure relates to a method for two photon printing using a quantity of photo-polymerizable material having a first material photo-polymerizable via an optical signal at a first wavelength, and a second material photo-polymerizable via an optical signal at a second wavelength. The method comprises using a laser to generate a first optical beam at a first fixed wavelength, and a second optical beam at a second tunable wavelength. The method further comprises using a dichroic mirror to coaxially align the first and second optical beams, and using a 4f lens system to direct the coaxially aligned first and second optical beams into an objective lens disposed elevationally apart, along a Z-axis, from the quantity of photo-polymerizable material containing the first and second materials. The objective lens focuses the coaxially aligned first and second optical beams to a focused image plane on or within the quantity of polymerizable material. The method further includes using first and second galvanometer mirror subsystems to steer the coaxially aligned first and second optical beams within the image plane, and using the coaxially aligned first and second optical beams to selectively photo-polymerize either the first material using the first optical beam operating at the first wavelength, or both the first material and the second material simultaneously using the second optical beam operating at the second wavelength.

In still another aspect the present disclosure relates to a system for two photon printing using a quantity of photo-polymerizable material having a first material photo-polymerizable via an optical signal at a first wavelength, and a second material photo-polymerizable via an optical signal at a second wavelength. The system comprises a laser to generate a first optical beam at a first fixed wavelength and a second optical beam at a second tunable wavelength. The system further includes a mirror to coaxially align the first and second optical beams, a lens system, and an objective lens disposed downstream of the lens system relative to a direction of travel of the coaxially aligned first and second optical beams. The lens system is configured to direct the coaxially aligned first and second optical beams into the objective lens. The objective lens is operative to focus the coaxially aligned first and second optical beams to a focused image plane on or within the quantity of polymerizable material. The system further includes a beam steering subsystem configured to steer the coaxially aligned first and second optical beams within the image plane and using the coaxially aligned first and second optical beams to selectively photo-polymerize either only the first material using the first optical beam operating at the first wavelength, or both the first material and the second material simultaneously using the second optical beam operating at the second wavelength.

In still another aspect the present disclosure relates to a method for two photon printing using a quantity of photo-polymerizable material having a first material photo-polymerizable via an optical signal at a first wavelength, and a second material photo-polymerizable via an optical signal at a second wavelength. The method may comprise generating a first optical beam at a first wavelength; generating a second optical beam at a second wavelength different from the first wavelength; and coaxially aligning the first and second optical beams. The coaxially aligned beams may be directed into an objective lens disposed elevationally apart, along a Z-axis, from the quantity of photo-polymerizable material containing the first and second materials. The objective lens focuses the coaxially aligned optical beams to an image plane on or within the quantity of polymerizable material. The method further involves steering the coaxially aligned optical beams within the image plane and using the first and second optical beams to photo-polymerize either only the first material using the first optical beam operating at the first wavelength, or at least the second material using the second optical beam operating at the second wavelength.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

Corresponding reference numerals indicate corresponding parts throughout the several views of the drawings.

FIG. 1 is a high level block diagram of one example of a dual wavelength 2PP 3D printing system in accordance with the present disclosure;

FIG. 2 is a simplified diagram illustrating a schematic of the a portion of the system of FIG. 1, and how commercially available optical design software is used to determine the optimum distances between various optical components;

FIG. 2a is a diagram of additional components that may be used for transmitting the coaxially aligned beams to the beam steering components of the system;

FIG. 3 is a simplified side view schematic representation of a new lens configuration for enabling the printing of tall 3D structures which would not be possible with conventional objective lens;

FIG. 4 is a picture of the system of FIG. 3 taken from above the system; and

FIG. 5 is a high level flowchart of one example of various operations that may be performed by the system of FIG. 1 in carrying out a 2PP 3D printing operation.

### DETAILED DESCRIPTION

Example embodiments will now be described more fully with reference to the accompanying drawings.

The present disclosure involves systems and methods relating to a new multi-wavelength laser scanning system in two-photon printing (2PP). 2PP is a direct laser writing 3D printing method using non-linear absorption activated inside of tightly focused femtosecond laser voxels. This enables the printing of submicron features with unprecedented accuracy. By integrating multiple laser beams with various choices of wavelengths, the systems and methods described herein provide a new pathway to fabricating a multi-material three-dimensional (3D) structure in a single vat process and achieving increased printing resolution beyond the diffraction limit.

In one embodiment a system of the present disclosure uses multi-femtosecond laser beams with different wavelengths coaxially aligned through a dichromic mirror to produce spatially overlapped voxels at the image plane of the high refractive index objective lens. In one embodiment a galvanometer mirror scanner rapidly scans multi voxels simultaneously, or sequentially at the image plane inside of the resin within the field of view (FOV) of an optical system. In one embodiment a 4f system composed of telecentric scan and tube lenses between the galvo mirror scanner and the objective lens relays the steered laser beams with off-axis angle to the entrance pupil of an objective lens. In one embodiment a substrate may be moved in three-axis relative to the voxels by an integrated three-axis motorized linear stage which enables augmented large scale 3D printing by either stitching or simultaneous motion control of a galvo mirror scanner and the linear stages of the three-axis motorized linear stage.

The systems and methods for dual wavelength 2PP printing as described in the following paragraphs can provide multi-material printing by two distinct wavelengths. In this manner, one is able to independently control disparate photo chemistries. For example, in some embodiments, a first and a second polymer in a mixture can be selectively polymerized. In some embodiments, a multi-step polymerization may be controlled by selective irradiation at two wavelengths. Such photochemistries are described in Ehrmann et al., Colorful 3D Printing: A Critical Feasibility Analysis of Mult-Wavelength Additive Manufacturing, J. American Chemical Society 145:45 (2023); and Hobich et al., Synergistic, Orthogonal, and Antagonistic Photochemistry for Light-Induced 3D Printing, Macromolecular Chemistry and Physics 224:1 (2023). In some aspects, such orthogonal activation of target materials enables highly precise printing of spatially controlled materials' optical, mechanical, and electrochemical properties in sub-micron in 3D fashion, including refractive index, porosity, density, Young's modulus, and wettability. And still further, the multi-wavelength feature of the present disclosure can enhance the resolution of a printed structure by advanced beam shaping that controls the size, shape, and relative locations of voxels at different wavelengths. For example, the size of printed structure by non-degenerative two photon polymerization can be dictated by overlapping of two voxels at different wavelengths. In addition, implementations of stimulated emission depletion (STED) approach by advanced beam shaping can be introduced. A secondary beam shaped in a donut shape using a phase mask can quench a polymerization reaction that is excited by a primary gaussian beam, resulting polymerization of just a tightly confined core region.

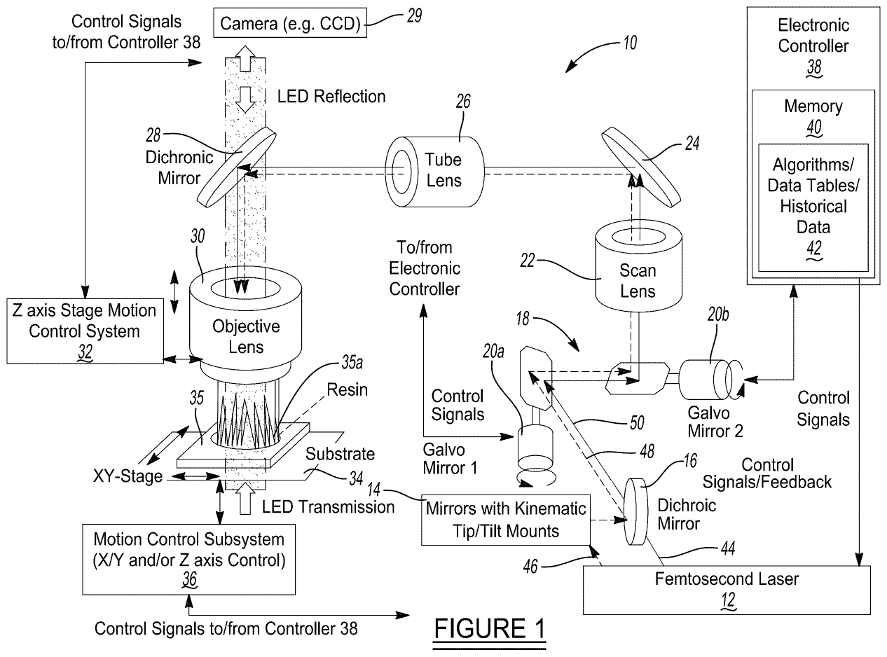

Referring now to FIG. 1, a system 10 in accordance with one embodiment of the present disclosure is illustrated in high level block diagram form. In this example the system 10 forms a dual wavelength 2PP system which makes use of, in one embodiment, a femtosecond laser 12 (hereinafter simply “laser 12”), as well as a subassembly of mirrors with kinematic tip/tilt mounts 14 for steering an optical beam, a first dichroic mirror 16, an optical subsystem 18 having a first galvanometer mirror 20a and a second galvanometer mirror 20b, a scan lens 22, a second mirror 24, a tube lens 26, a second dichroic mirror 28, an objective lens 30, a Z-axis stage control system 32 (e.g., DC stepper motors and/or linear actuators) for controlling Z-axis positioning of the objective lens, an X/Y stage 34, and a motion control subsystem 36 (e.g., DC stepper motors and/or linear actuators). The purpose of the subassembly of mirrors is 14 is to coaxially align both tunable beam 46 and fixed beam 44.

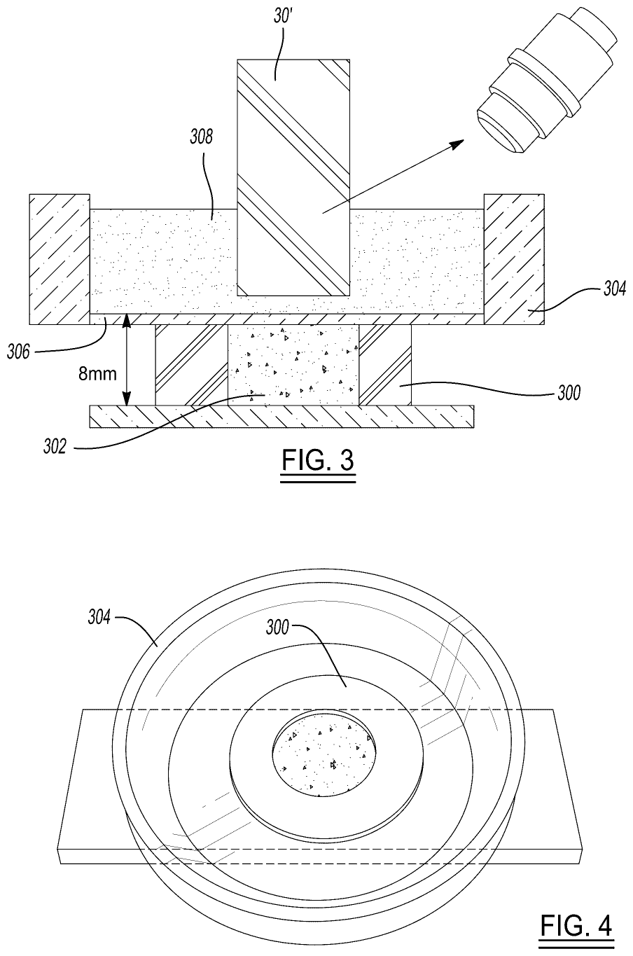

The X/Y stage 34 may be used to support a substrate 35 on which a quantity of resin 35a is present. The resin 35a can be self-sustained by surface tension and capillary force if using an objective lens with short working distance (so called “dip-in” method). If using a long working distance objective lens, the resin needs to be contained in a container, such as shown and described in connection with FIG. 3.

The first and second galvanometer mirrors 18 and 20, respectively, may be viewed as a beam steering subsystem within two orthogonal planes. An optional camera (e.g., CCD) 29 may be used to receive reflections from the second dichroic mirror 28 to view a photo-planarization in operation in real time. Optionally, another camera can be located under the sample to view the real image. One more set of scan and tube lenses can be placed between the two galvo mirrors, which can even further improve the beam relay quality.

In some embodiments the system 10 may also include an electronic controller 38 for controlling one or more components of the system 10. In this example the electronic controller 38 also includes a memory 40 (e.g., non-volatile RAM/ROM, EEPROM, DRAM, etc.) for storing, for example and without limitation, one or more algorithms, software modules, data tables, performance curves and/or historical data. In this example the electronic controller 38 may be used to control one or more of the laser 12, the galvanometer mirrors 18 and 20, the Z-axis motion control subsystem 32 and/or the substrate motion control subsystem 36.

In one embodiment the laser 12 generates a fixed beam 44 at 1045 nm and a tunable beam 46 ranging from about 680 nm to about 1300 nm. In other embodiments different wavelengths may be used, and the precise wavelength of wavelength spectrum for each beam may be selected at least in part on the properties of the material composition of the resin be used. Still further, while in some embodiments the laser 12 comprises one or more femtosecond lasers, it is possible that for some materials being used, shorter pulsed lasers operating in the nanosecond time frame, or even a continuous wave (CW) laser, may be used to project one of the two beams.

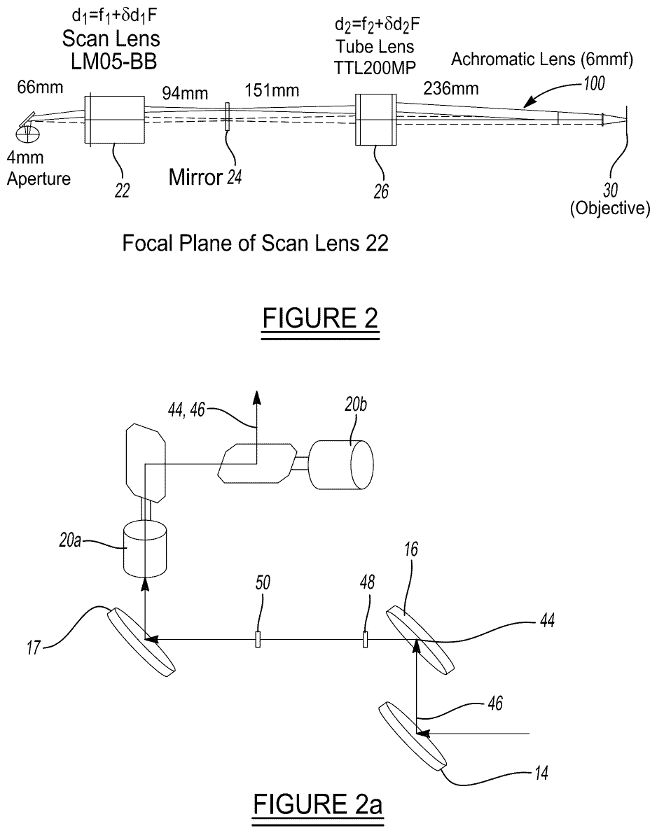

The laser 12 in some embodiments may be the InSight® X3 laser commercially available from MKS/Spectra-Physics of Milpitas, CA. The beams 44 and 46 are coaxially combined by the dichroic mirror 16 (e.g., dichroic mirror Di02-R980-25×36, Semrock optical filters, commercially available from IDEX Health & Science LLC of Rochester, NY). The dichroic mirror 16 reflects the tunable beam 46 while transmitting fixed beam 44. For the alignment, a first planar element 48 with a first pinhole and a second planar element 50 with a second pinhole are used (the pinholes not being visible in the Figure). In this example both pinholes need to be placed between the dichroic mirror 16 and the galvo mirror 20a. In some embodiments the pinholes may be below 500 um. The subassembly 14 of mirrors with kinematic tip/tilt mounts is utilized for coaxially aligning the beam 46 with the beam 44. This is accomplished by positioning the planar elements 48 and 50 such that the center of the fixed beam 44 passes through these two pinholes in the first planar element 48 and the second planar element 50. Then the tunable beam 46 is adjusted to pass through these two pinholes by adjusting the tip-tilt of the two mirrors in the subassembly 14 with kinematic tip/tilt mirror mounts, as needed to steer the tunable beam 46 such that the tunable beam is coaxially aligned with the two pinholes in the first planar element 48 and second planar element 50. A beam viewing camera may be used to make a more detailed check of the overlapping of the two beams in front of the two pinholes. This procedure coaxially aligns the fixed and tunable beams 44 and 46, respectively. In addition, with brief reference to FIG. 2a, a set of two more mirrors 17a and 17b with kinematic tip/tilt mounts may be disposed between the first galvo mirror 20a and the second planar plane (i.e., plate 50) with its pinhole. This is to correctly send the coaxially aligned laser beams 48,50 to the steering system 18. The two beams 48,50 should be aligned at the center of the galvo mirror reflecting element in galvanometer mirror 20a. The laser beams 44,46 are directed to the mirror reflecting element in galvanometer mirror 20a at 45 degrees in the plane of incidence that is perpendicular to the surface of the mirror reflecting element in component 20a. Then, both beams 44 and 46 are sent to the optical steering subsystem 18, which as noted above in some embodiments is comprised of two galvanometer mirror scanners 20a and 20b for steering the coaxially aligned beams 44 and 46. Thus, the galvanometer mirrors 20a,20b steer the laser beams 48,50. The relay of the optics 22, 26, 30 transform the steering of the laser beams 48,50 to the linear translation in X/Y plane at the sample 34,35. The optical beam steering subsystem 18 in some embodiments may be a commercially available system, such as the Excelliscan 14, which is commercially available from ScanLAB GmbH of Munich, Germany. A 4f system which in some embodiments may comprise the telecentric scan lens 22 (e.g., TTL200MP, commercially available from Thorlabs Inc. of Newton, NJ) and the telecentric tube lens 26 (e.g., LM05-BB, commercially available from Thorlabs) relays the steered laser beams 44/46 using mirrors 24 and 28 at an off-axis angle at the entrance pupil of the objective lens 30. This 4f system transforms the rotation motion of the laser beams 48,50 by steering optics 20a/b to the linear motion at the focal plane of the objective lens 30. Here, the telecentric scan lens 22 produces a flat image plane and a spot size that suffers minimal distortion as the angle of the incident beam with respect to the optical axis of the objective lens 30 is varied.

The distances among the components may be carefully designed using suitable optical design software. In some embodiments, the optical software may be Zemax optical design software, commercially available from Ansys, Inc. of Canonsburg, Pa. The careful design and consideration of the distances between the components produces a minimal distortion of the focal plane with the off-axis angle by the galvo mirror (FIG. 2). One specific example of the design of the distances between the components is shown in the simplified schematic representation 100 in FIG. 2. Here, we ignore the reflecting mirror 24 and dichroic mirror 28 as they are simple reflecting elements. The distances between the lenses 22 and 26 is determined by the back focal length of both lenses, 94 mm (f₁) and 151 mm (f₂), respectively. The distances between steering elements 18 and scan lens 22 (d₁), and between tube lens 26 and objective lens 30 (d₂) are determined by d₁=f₁+δd₁ and d₂=f₂+δd₂, respectively, where δd₁=−δd₂*(f₁/f₂)². Here we chose 66 mm and 236 mm for d₁ and d₂. d₂ is much larger than d₁ as we try to minimize the X/Y scan distortion caused by the movement of the objective lens in z-direction that cause changes in d₂ value. The larger the d₂ value, the smaller the distortion as the relative changes in d₂ becomes smaller. Note that the values do not exactly match with the calculation. This is because the distances are measured from the surfaces of the optics which can be different from the actual optical surface.

The scanning of the focal spot of the laser 12 inside of the resin 35 prints arbitrary 2D patterns in XY plane. The laser beams 44/46 are scanned by the galvanometer mirror scanners 20a and 20b within the field of view (“FOV”) of the objective lens 30. In one embodiment the field of view of the objective lens 30 may be, without limitation, about 500 μm×500 μm. However, the exact value can vary depending on the objective lens f-number that determines the acceptance angle of the incident laser beam, and magnification of the objective lens. The Z-axis stage motion control subsystem 32 can be used to move the objective lens 30 in the Z-axis to generate a 3D structure. Alternatively, Z-axis movement of the substrate 34 may be carried out using the motion control subsystem 36 to effect building a 3D structure. Printing a structure whose lateral dimension is larger than the FOV of the objective lens 30 will require a stitching process to stitch two or more sections of the 3D part together. This may be accomplished in one example by translating the resin 35a by linear X/Y motion stages (e.g., via a precision, low-profile linear motor stage, such as the V-508 linear motor stage commercially Physik Instrumente GmbH & Co. KG, of Karlsruhe, Germany).

The system 10 and methods described herein are also well suited for printing tall structures. It will be appreciated that the height of a structure fabricated using a 2PP system is limited by the working distance of the high refractive index objective lens used, which is typically less than 300 μm. This distance restricts the maximum height of printable structures, as the lens's output aperture risks colliding with the top of any structure taller than this limit. Additionally, the 2PP system relies on capillary forces to hold the resin in place. When the distance between the objective lens 30 and the substrate 34 increases beyond a certain point, the resin may detach from the objective lens due to weakened capillary forces. In practice, the resin should touch the resin or a liquid with the same refractive index to the resin—so called “dip-in” printing. This detachment disrupts the printing process and further limits the achievable height of the structures.

With reference to FIGS. 3 and 4, to resolve the above-described limitation of the objective restricting the maximum height of 3D printed parts, in one example the system 10 makes use of a long working distance for the dual wavelength 2PP system. The criterion for long working distance is that the resin cannot be placed between the objective lens and the substrate solely by capillary force due to the large distance. Then, this will require a container to hold the resin.

In various embodiments, the systems and methods of the present disclosure may employ a first material (e.g., “Material A”) photo-polymerizable via an optical signal at a first wavelength, and a second material (e.g., “Material B”), which is photo-polymerizable via an optical signal at a second wavelength. In some embodiments, the first material may be photo-polymerizable only at the first wavelength, so that presence of the second wavelength may photo-polymerize only the second material but not the first material. In other embodiments, the first material may be photo-polymerizable at either the first wavelength or the second wavelength, so that presence of the second wavelength may photo-polymerize both the first material and the second material simultaneously. As a more complete summary of the above scenarios/embodiments, in various embodiments the systems and methods described herein may be used to selectively carry out polymerization such as:
Wavelength 1 used to polymerize Material A only;
Wavelength 2 used to polymerize Materials A and B simultaneously.

In various embodiments the systems and methods described herein may also be used to selectively polymerize the Materials A and B by using:
Wavelength 1 to polymerize Material A only; and
Wavelength 2 to polymerize Material B only.

In still further various embodiments, the systems and methods described herein may also be used to selectively polymerize Materials A and B by using:
Wavelength 1 to polymerize Material A only; and
Wavelength 2 to polymerize at least Material B.

Each such material may comprise a resin system comprising a photocurable resin and photoactivator operable to form a polymeric material upon irradiation by a light source, e.g., a femtosecond laser emitting ultraviolet light at a wavelength suitable to initiate curing of the resin. In various embodiments, compositions comprise a homogenous mixture of the components of each material, i.e., with the components of a first resin system in admixture with the components of a second resin system in the composition. In various embodiments, methods of the present disclosure direct laser light to a substrate consisting of or containing (e.g., in a vat or other suitable container) the admixture of the first resin system and the second resin system.

In one specific implementation the objective lens may be a model XLSLPLN25XGMP objective, commercially available from Olympus Life-Science of Tokyo, JP, which has a NA=1. A new printing configuration is also used, as shown in FIGS. 3 and 4. A gasket 300 was fabricated to securely hold printing resin 302 up to 8 mm tall. A glass bottom petri dish 304 with #1.5 cover glass (160 mμ thick) 306 covers the resin and is filled with a refractive index matched medium 308 (e.g., glycerin water and silicon oil). This configuration allows printing a tall structure close to the working distance of the objective lens 30′ (i.e., 8 mm). Also, the cover glass 306 physically separates precursor resin 302 from the refractive index medium 308, which prevents drift of the structure by the rapid movement of the objective lens 30′. Thus, it will be appreciated that to fabricate a large structure, one will also need to move the XY stage. Thus, the fast or rapid movement is to indicate this lateral movement of the sample.

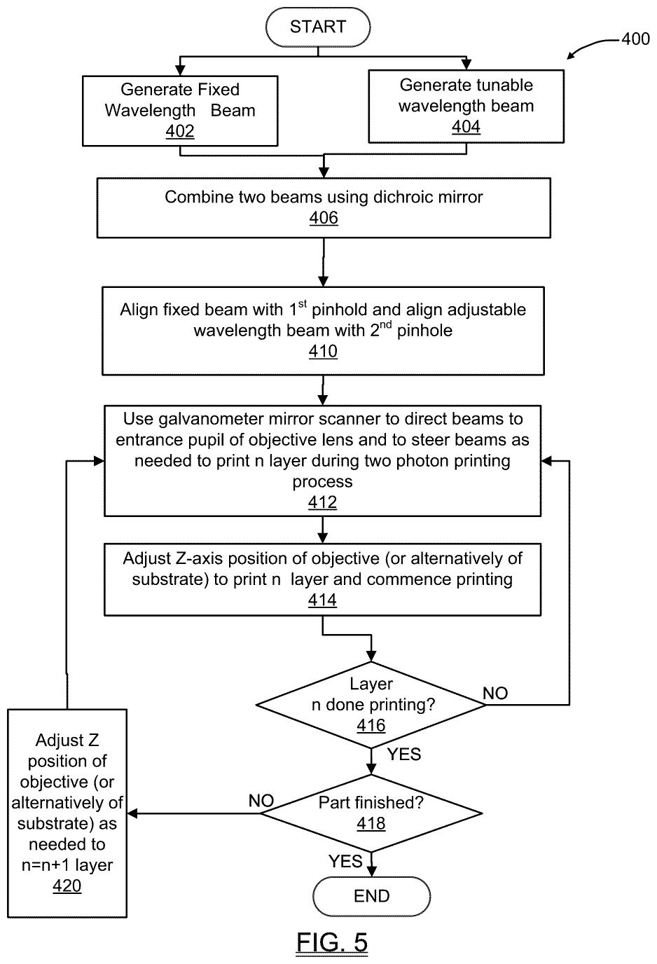

Referring briefly to FIG. 5, a flowchart 400 is shown of one example of how various operations may be performed using the system 10 in its various embodiments to perform a 2PP 3D printing operation to print a part. At operations 402 and 404 the fixed wavelength and tunable wavelength beams 44 and 46, respectively, are generated at the desired wavelengths. At operation 406 the dichroic mirror 44 may be used to combine the two beams. At operation 410 the fixed beam 44 and tunable beam 46 may be aligned with the first and second pinholes. The aligned both beams may be sent to the scanner at a correct angle (45 degrees in the incident plane of the laser beam which is perpendicular to the mirror) by a set of two kinematic tip/tilt mirrors 17a and 17b shown in FIG. 2a (Operation 410). At operation 412 the galvanometer mirror scanner system of components 18 and 20 may be used to direct the now coaxially aligned beams 44/46 to the entrance pupil of the objective lens 30 as needed to begin printing a layer of a part. At operation 414 the Z-axis position of the objective lens 30 (or alternatively the Z-axis position of the substrate 34 may be adjusted as needed and printing may commence. At operation 416 a check is made (e.g., by the electronic controller 38) if the layer is done printing, and if not, then operations 410, 412, and 414 are repeated. If the check at operation 416 indicates that printing of the current layer is complete, then a check is made (e.g., by the electronic controller 38) at operation 418 to determine if the part is fully complete. If this produces a “NO” answer, then the Z-axis position of the objective lens 30 is adjusted as needed to ready it for printing of the next material layer (i.e., layer n=n+1), and operations 412 and 414 are repeated. If the check at operation 418 indicates that the part is fully complete, then the 2PP printing process ends.

When the check at operation 420 (e.g., by the electronic controller 38) indicates that the part is finished to determine if the part is finished.

The systems and methods of the present disclosure are expected to find utility in a wide variety of applications. One application is in inertial confinement fusion (ICF). ICF is an approach to ignite DT fuel in a capsule using a direct or indirect laser drive. By doing many shots per second, the systems and methods of the present disclosure can be used to create clean energy with little nuclear waste. Targets for ICF today are complicated, high-precision devices with challenging requirements (e.g., sphericity, roughness, material composition, etc.) that take many months to fabricate. Additive manufacturing (AM) via two-photon polymerization (2PP) can potentially streamline capsule fabrication by directly integrating various capsule components, including a full density ablator shell, a layer of low-density inner foam, and the fill tube, into a single print with high precision, reproducibility, and throughput. The dual-wavelength 2PP system can add another significant degree of flexibility in the use of materials having differing physical and mechanical properties by multi-material printing in unprecedented resolution. Other key potential material combinations include density control, Z material doping, soft/hard material compositions, polymer/metal printing, and the printing of high precision medical devices.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items. As used herein, the term “about”, when used immediately previous to a specific recited value, denotes the specific recited value as well as all values, inclusive, from +/−10% of the specific recited value.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. A method for two photon printing using a quantity of photo-polymerizable material having a first material photo-polymerizable via a first optical signal at a first wavelength or via a second optical signal at a second wavelength, and a second material photo-polymerizable via the second optical signal at the second wavelength, the method comprising:
generating a first optical beam at a first wavelength;
generating a second optical beam at a second wavelength different from the first wavelength;
coaxially aligning the first and second optical beams;
directing the coaxially aligned first and second optical beams into an objective lens disposed elevationally apart, along a Z-axis, from the quantity of photo-polymerizable material containing the first and second materials, the objective lens focusing the coaxially aligned optical beams to an image plane on or within the quantity of polymerizable material;
steering the coaxially aligned optical beams within the image plane and using the first and second optical beams to photo-polymerize:
the first material using the first wavelength; or
both the first material and the second material simultaneously using the second wavelength.

2. The method of claim 1, further comprising using the coaxially aligned optical beams to photopolymerize both of the first and second materials.

3. The method of claim 1, further comprising combining the first and second optical beams before coaxially aligning the first and second optical beams.

4. The method of claim 3, wherein the combining the first and second optical beams comprises using a dichroic mirror.

5. The method of claim 1, wherein directing the coaxially aligned first and second optical beams into an objective lens comprises using a telecentric scan lens to direct the coaxially aligned first and second optical beams into the objective lens.

6. The method of claim 1, wherein directing the coaxially aligned first and second optical beams into an objective lens comprises using a telecentric tube lens to direct the coaxially aligned first and second optical beams into the objective lens and create the image plane, and wherein the image plane is a flat image plane.

7. The method of claim 1, wherein directing the coaxially aligned first and second optical beams into an objective lens comprises using a telecentric scan lens and a telecentric tube lens disposed downstream, relative to a direction of travel of the coaxially aligned first and second optical beams, to direct the coaxially aligned first and second optical beams into the objective lens.

8. The method of claim 1, further comprising using a Z-axis motion control subsystem to adjustably position the objective lens along the Z-axis relative to the quantity of photo-polymerizable material.

9. The method of claim 1, further comprising using a X-axis and Y-axis motion control subsystem to control movement within an X/Y plane of the quantity of photo-polymerizable material.

10. The method of claim 1, wherein generating the first optical beam comprises using a laser.

11. The method of claim 10, wherein using a laser comprises using a femtosecond laser generating a fixed wavelength beam at 1045 nm.

12. The method of claim 1, wherein generating the second optical beam comprises using a femtosecond laser generating a tunable wavelength from 680 nm to 1300 nm.

13. The method of claim 1, wherein the first and second optical beams are generated by a femtosecond laser, and wherein:
the first optical beam is fixed in wavelength and has a wavelength of about 1045 nm; and
the second optical beam is tunable in wavelength and has a wavelength between 680 nm and 1300 nm.

14. The method of claim 1, further comprising:
initially using a pair of spaced apart fixed plates having first and second pinholes to align the fixed first optical beam such the that first optical beam is able to pass through the first and second pinholes; and
using a pair of mirrors with kinematic mounts to align the second optical beam such that the second optical beam passes through the first and second pinholes.

15. The method of claim 1, further comprising using an electronic controller to control generation of at least one of the first or second optical beams.

16. The method of claim 1, further comprising using an electronic controller to control at least one of:
Z-axis adjustable positioning of the objective lens; or
steering of the coaxially aligned first and second optical beams.

17. A method for two photon printing using a quantity of photo-polymerizable material having a first material photo-polymerizable via an optical signal at a first wavelength or a second optical signal at a second wavelength, and a second material photo-polymerizable via the second optical signal at the second wavelength, the method comprising:
generating a first optical beam at a first fixed wavelength, and a second optical beam at a second tunable wavelength;
using a dichroic mirror to coaxially align the first and second optical beams;
using a 4f lens system to direct the coaxially aligned first and second optical beams into an objective lens disposed elevationally apart, along a Z-axis, from the quantity of photo-polymerizable material containing the first and second materials, the objective lens focusing the coaxially aligned first and second optical beams to a focused image plane on or within the quantity of polymerizable material;
using first and second galvanometer mirror subsystems to steer the coaxially aligned first and second optical beams within the image plane and using the coaxially aligned first and second optical beams to selectively photo-polymerize:
the first material using the first wavelength; or
the first and second materials simultaneously using the second wavelength.

18. A system for two photon printing using a quantity of photo-polymerizable material having a first material photo-polymerizable via an optical signal at a first wavelength or a second optical signal at a second wavelength, and a second material photo-polymerizable via the second optical signal at the second wavelength, the system comprising:
a laser system to generate a first optical beam at a first fixed wavelength and a second optical beam at a second tunable wavelength;
a mirror to coaxially align the first and second optical beams;
a lens system;
an objective lens disposed downstream of the lens system relative to a direction of travel of the coaxially aligned first and second optical beams;
the lens system configured to direct the coaxially aligned first and second optical beams into the objective lens;
the objective lens operative to focus the coaxially aligned first and second optical beams to a focused image plane on or within the quantity of polymerizable material; and
a beam steering subsystem configured to steer the coaxially aligned first and second optical beams within the image plane and using the coaxially aligned first and second optical beams to selectively photo-polymerize:
only the first material using the first optical beam operating at the first wavelength; or
both the first and second materials simultaneously using second optical operating at the second wavelength.

19. A method for two photon printing using a quantity of photo-polymerizable material having a first material photo-polymerizable via an optical signal at a first wavelength, and a second material photo-polymerizable via an optical signal at a second wavelength, the method comprising:
generating a first optical beam at a first wavelength;
generating a second optical beam at a second wavelength different from the first wavelength;
coaxially aligning the first and second optical beams;
directing the coaxially aligned first and second optical beams into an objective lens disposed elevationally apart, along a Z-axis, from the quantity of photo-polymerizable material containing the first and second materials, the objective lens focusing the coaxially aligned optical beams to an image plane on or within the quantity of polymerizable material;
steering the coaxially aligned optical beams within the image plane and using the first and second optical beams to photo-polymerize:
only the first material using the first optical beam operating at the first wavelength; or
at least the second material using the second optical beam operating at the second wavelength.

20. The system of claim 19, wherein the first material may also be photo-polymerizable via the second optical beam at the second wavelength, so that the second optical beam operating at the second wavelength is operative to also simultaneously polymerize the first material.

21. The system of claim 19, wherein the second optical beam operating at the second wavelength is operative to only polymerize the second material.
